(19) United States
(12) Patent Application Publication
(10) Pub. No.: US 2015/0355410 A1
(43) Pub. Date: Dec. 10, 2015

(54) OPTICAL GRATING COUPLER HAVING WAVELENGTH TUNABLE STRUCTURE

(71) Applicant: Korea Advanced Institute of Science and Technology, Daejeon (KR)

(72) Inventors: Hyo Hoon PARK, Daejeon (KR); Jong Hun KIM, Daejeon (KR); Sun Kyu HAN, Daejeon (KR); Min Jung BAE, Daejeon (KR)

(21) Appl. No.: 14/690,126

(22) Filed: Apr. 17, 2015

(30) Foreign Application Priority Data
Jun. 9, 2014 (KR) 10-2014-0069326

(51) Int. Cl. G02B 6/34

(52) U.S. Cl. CPC G02B 6/34

(57) ABSTRACT

A structure of an optical grating coupler for tuning the center wavelength of signals which are propagated to a waveguide by changing the effective refractive index of the optical grating coupler is provided. The optical grating coupler includes a region for changing the effective refractive index of the optical grating coupler, which is included in the inside or outside of the optical grating coupler. The region receives a signal for changing the effective refractive index of the optical grating coupler.

### CROSS-REFERENCE TO RELATED APPLICATIONS

A claim for priority under 35 U.S.C. §119 is made to Korean Patent Application No. 10-2014-0069326 filed Jun. 9, 2014, in the Korean Intellectual Property Office, the entire contents of which are hereby incorporated by reference.

### BACKGROUND

Embodiments of the inventive concepts described herein relate to an optical grating coupler having a tunable functions, and more particularly, to a structure for tuning a center wavelength of a grating coupler which can increase the coupling efficiency out range of the center wavelength by changing the effective refractive index of the optical grating coupler.

A conventional optical grating coupler is a passive device which uses diffraction and interference phenomena of light generated by grating structures, each of which has a certain period, based on a Bragg grating theory. This optical grating coupler may change a propagation direction of light to a variety of directions and may change light which is propagated in a vertical direction to light which is propagated in a horizontal direction. The optical grating coupler is used not only to provide optical signals to a chip or an optical waveguide from the outside but also by a coupling method in vertical connection between chips.

However, the conventional optical grating coupler has wavelength dependency by the structural characteristic of gratings. The conventional optical grating coupler obtains a maximum coupling efficiency at a specific center wavelength from the wavelength dependency. However, the reduction of the coupling efficiency of the optical grating coupler leads to additional optical loss in an area of wavelengths shifted from the specific center wavelength.

Accordingly, a physical structure of the conventional optical grating coupler is used for various operational wavelengths deviated from the specific center wavelength. Therefore, there is a disadvantage to increase power budgets of WDM (wavelength division multiflexing) systems which use multiple wavelengths as signals.

Therefore, it is needed to provide a structure of an optical grating coupler which can change a center wavelength in an active manner by changing the effective refractive index of the optical grating coupler through electric control.

### SUMMARY

Embodiments of the inventive concepts provide an optical grating coupler which tune a center wavelength in an active manner by changing the effective refractive index of an optical grating coupler through electric control.

Embodiments of the inventive concepts provide structures of an optical grating coupler which uses the thermo-optic effect, the electro-optic effect, and the acousto-optic effect in a process of changing the effective refractive index of the optical grating coupler, which are detailed means of changing the effective refractive index of the optical grating coupler through electric control.

One aspect of embodiments of the inventive concept is directed to provide an optical grating coupler including gratings, each of the gratings configured to have a certain period and a certain depth, which is disposed in a waveguide. The optical grating coupler may include an active region for changing the effective refractive index of the optical grating coupler, which is included in the inside or outside of the optical grating coupler.

Each of the gratings may be coupled with an optical signal with maximum coupling efficiency at a center wavelength of the optical grating coupler to the waveguide, and the center wavelength can be tuned by change in the effective refractive index of the optical grating coupler.

The optical grating coupler may be used in an optical switch which selectively tunes the center wavelength to have different coupling efficiency depending on the wavelength.

The optical tunable grating coupler may be used in an optical filter which selectively tunes the center wavelength to have different coupling efficiency depending on the wavelength.

The optical grating coupler may be used in an optical amplitude modulator by changing of the coupling efficiency at operational wavelengths.

The effective refractive index of the optical grating coupler may be changed by the thermo-optic effect.

The region for changing the effective refractive index of the optical grating coupler may be formed based on at least one of materials or semiconductor materials which suffer a change of the refractive index by heating.

The region for changing the effective refractive index of the optical grating coupler may be formed based on silicon photonics to use the thermo-optic effect, and the effective refractive index of the optical grating coupler may be changed by joule heating according to bias in high resistive region with a PN junction or a P-i-N junction.

The effective refractive index of the optical grating coupler may be changed by the electro-optic effect according as an electric signal is supplied to the region for changing the effective refractive index of the optical grating coupler.

The region for changing the effective refractive index of the optical grating coupler may be formed based on at least one of materials or semiconductor materials having an electro-optic coefficient of a certain reference value or more to use the electro-optic effect.

The region for changing the effective refractive index of the optical grating coupler may be formed based on silicon photonics to use the electro-optic effect, and the effective refractive index of the optical grating coupler may be changed by the carrier plasma dispersion effect in a PN junction or a P-i-N junction when impurities are doped into the region for changing the effective refractive index of the optical grating coupler.

The effective refractive index of the optical grating coupler may be changed by the acousto-optic effect according as an acoustic signal is provided to the region for changing the effective refractive index of the optical grating coupler.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a drawing illustrating a structure of an optical grating coupler which tunes a center wavelength according to an exemplary embodiment of the inventive concept;

FIG. 2 is a drawing illustrating optical signals which have a variety of center wavelengths according as a center wavelength of an optical signal is tuned by an optical grating coupler according to an exemplary embodiment of the inventive concept;

FIGS. 3A and 3B are drawings illustrating a first method and a second method of forming gratings on an optical grating coupler according to an exemplary embodiment of the inventive concept;

FIG. 4 is a drawing illustrating a third method of forming gratings on an optical grating coupler according to an exemplary embodiment of the inventive concept; and

FIG. 5 is a pictorial drawing illustrating an optical grating coupler according to an exemplary embodiment of the inventive concept.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept.

Unless otherwise noted, like reference numerals denote like elements throughout the attached drawings and written description, and thus descriptions will not be repeated. In the drawings, the sizes and relative sizes of layers and regions may be exaggerated for clarity.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Hereinafter, a description will be given in detail for exemplary embodiments of the inventive concept with reference to the accompanying drawings. However, the inventive concept is not limited to exemplary embodiments described below or depicted in the drawings. Also, the same reference numerals shown in each of drawings represents the same members, respectively.

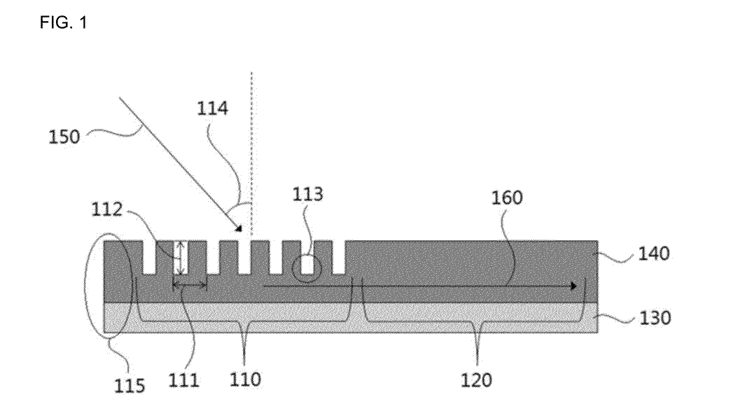

FIG. 1 is a drawing illustrating a structure of an optical grating coupler which tunes a center wavelength according to an exemplary embodiment of the inventive concept.

Referring to FIG. 1, the optical grating coupler denoted by 110 according to an exemplary embodiment of the inventive concept may be disposed to connect to a waveguide 120 formed in a predetermined direction. Herein, the optical grating coupler 110 and the waveguide 120 may be formed on a core layer 140 laminated on a cladding layer 130. For example, the core layer 140 may be formed of silicon and the cladding layer 130 may be formed of silicon oxide.

Gratings, each 113 of which has a certain period 111 and a certain depth 112, may be formed in the optical grating coupler 110. Accordingly, the optical grating coupler 110 may propagate an optical signal 160 of a horizontal component to the waveguide 120 by changing an optical signal 150 of a vertical component, which is input thereto, to the optical signal 160 of the horizontal component, which has a predetermined center wavelength having its maximum efficiency. Hereinafter, the center wavelength of the optical signal 160 of the horizontal component may mean a center wavelength having maximum efficiency of the optical grating coupler 110.

Herein, the optical signal 160 of the horizontal component, which is propagated to the waveguide 120, may be calculated using Equation 1 below.

$${k}_{in} sin ( {θ}_{in} ) + p \frac{2 π}{Λ} = {β}^{′} \qquad [ Equation 1 ]$$

In Equation 1, kᵢₙ represents the optical signal 150 of the vertical component, which is input to the optical grating coupler 110, and may be calculated using Equation 2 below.

$${k}_{in} = \frac{2 π}{λ} \qquad [ Equation 2 ]$$

In Equation 2, λ represents the wavelength of the optical signal 150 of the vertical component, which is input to the optical grating coupler 110.

Also, in Equation 1, θᵢₙ represents the incident angle 114 of the optical signal 150 of the vertical component, which is input to the optical grating coupler 110, and the incident angle 114 may be formed with the optical grating coupler 110. Also, p2π/Λ may represent an element associated with the physical structure of the grating 113 formed on the optical grating coupler 110. In more detail, p may represent the depth 112 of the grating 113 and Λ may represent the period 111 of the grating 113. β′ may represent a vector value of the optical signal 160 of the horizontal component, which is propagated to the waveguide 120, and may be calculated using Equation 3 below.

$${β}^{′} = ( \frac{2 π}{λ} ) {n}_{eff} \qquad [ Equation 3 ]$$

In Equation 3, n_{eff} represents the effective refractive index of the optical grating coupler 110. The center wavelength of the optical signal 160 of the horizontal component, which is propagated to the waveguide 120, is shifted in response to a change in β′.

Accordingly, to shift the center wavelength of the optical signal 160 of the horizontal component, which is propagated to the waveguide 120, the effective refractive index n_{eff} of the optical grating coupler 110 must be changed.

Therefore, to shift the center wavelength of the optical signal 160 of the horizontal component, which is propagated to the waveguide 120, the optical grating coupler 110 according to an exemplary embodiment of the inventive concept may include a region for changing the effective refractive index of the optical grating coupler 110 in the inside or outside thereof. Herein, a signal for changing the effective refractive index of the optical grating coupler 110 may be provided to the region 115 for changing the effective refractive index of the optical grating coupler 110.

For example, as a thermal signal is provided to the region 115 for changing the effective refractive index of the optical grating coupler 110, the effective refractive index may be changed by the thermo-optic effect. Herein, that the thermal signal is provided may mean that heat is supplied.

In more detail, for example, as the region 115 for changing the effective refractive index of the optical grating coupler 110 is formed based on at least one of materials or semiconductor materials having a thermo-optic coefficient of a certain reference value or more, if heat is supplied to the region 115, the effective refractive index may be changed based on the thermo-optic coefficient according to an increase in a temperature of the region 115. Herein, the material or the semiconductor material having the thermo-optic coefficient of the certain reference value or more may include thermo-optic polymers or silicon and the like.

Therefore, as the effective refractive index of the optical grating coupler 110 is changed due to the thermo-optic effect, the center wavelength of the optical signal 160 of the horizontal component, which is propagated to the waveguide 120, may be shifted. Herein, the thermo-optic coefficient of the region 115 for changing the effective refractive index of the optical grating coupler 110 may be determined according to whether the optical grating coupler 110 is formed of certain materials.

Also, as the region 115 for changing the effective refractive index of the optical grating coupler 110 is formed based on silicon photonics to use the thermo-optic effect, when impurities are doped into the region 115, the effective refractive index may be changed by joule heating according to bias in a PN junction or a P-i-N junction.

Also, as an electric signal is supplied to the region 115 for changing the effective refractive index of the optical grating coupler 110, the effective refractive index may be changed by the electro-optic effect. Herein, that the electric signal is supplied may mean voltage is supplied.

For example, as the region 115 for changing the effective refractive index of the optical grating coupler 110 is formed based on at least one of materials or semiconductor materials having an electro-optic coefficient of a certain reference value or more, if voltage is supplied to the region 115, the effective refractive index may be changed based on a change in an electric field of the region 115. Herein, the material or the semiconductor material having the electro-optic coefficient of the certain reference value or more may include electro-optic polymers and the like.

Accordingly, as the effective refractive index of the optical grating coupler 110 is changed due to the electro-optic effect, the center wavelength of the optical signal 160 of the horizontal component, which is propagated to the waveguide 120, may be shifted. Herein, the change in the electric field of the region 115 for changing the effective refractive index of the optical grating coupler 110 may be generated according to strength of the voltage supplied to the region 115.

In more detail, for example, as the region 115 for changing the effective refractive index of the optical grating coupler 110 is formed based on silicon photonics, when impurities are doped into the region 115, the effective refractive index may be changed by a carrier plasma dispersion effect in a PN junction or a P-i-N junction.

Also, as an acoustic signal is provided to the region 115 for changing the effective refractive index of the optical grating coupler 110, the effective refractive index may be changed by an acoustic-optic effect. Accordingly, as the effective refractive index of the optical grating coupler 110 is changed due to the acoustic-optic effect, the center wavelength of the optical signal 160 of the horizontal component, which is propagated to the waveguide 120, may be shifted.

The optical grating coupler 110 having the above-described structure may be used in an optical switch which selectively tunes the center wavelength having the maximum efficiency, an optical filter which tunes or selects the center wavelength having the maximum efficiency, or an optical signal modulator which changes the efficiency of coupling about a specific wavelength, and the like.

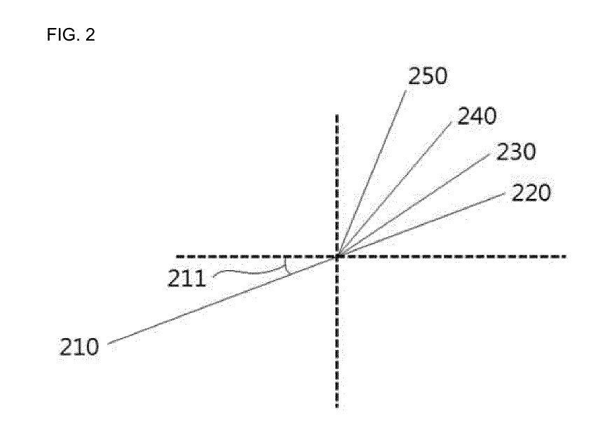

FIG. 2 is a drawing illustrating optical signals which have a variety of center wavelengths according as a center wavelength of an optical signal is shifted by an optical grating coupler according to an exemplary embodiment of the inventive concept.

Referring to FIG. 2, the optical grating coupler according to an exemplary embodiment of the inventive concept may change an optical signal 210 of a vertical component, which is input thereto to form a certain angle 211 therewith, to optical signals 220, 230, 240, and 250 of horizontal components having a variety of center wavelengths, and may propagate the optical signals 220, 230, 240, and 250 to a waveguide by controlling its effective refractive index.

For example, when the optical signal 210 of the vertical component is input to the optical grating coupler, as a first signal is provided to a region for changing the effective refractive index of the optical grating coupler, the effective refractive index of the optical grating coupler may be changed. The optical signal 210 of the vertical component may be changed to the optical signal 250 of a first horizontal component having a first center wavelength in response to the change in the effective refractive index. Also, when a second signal is provided to the region for changing the effective refractive index of the optical grating coupler, as the effective refractive index is less changed than the first signal is provided to the region for changing the effective refractive index of the optical grating coupler, the optical signal 210 of the vertical component may be changed to the optical signal 240 of a second horizontal component having a second center wavelength.

As such, in a structure of an optical coupler according to an exemplary embodiment of the inventive concept, the center wavelength of an optical signal having maximum efficiency of the optical coupler may be tuned as a signal for changing the effective refractive index of the optical grating coupler is provided to the region for changing the effective refractive index of the optical grating coupler. Herein, the signal provided to the region for changing the effective refractive index of the optical grating coupler may be set to one of a thermal signal, an electric signal, and an acoustic signal according to whether to use one of the thermo-optic effect, the electro-optic effect, and the acousto-optic effect.

Therefore, the optical coupler may propagate optical signals of horizontal components having a variety of center wavelengths to a waveguide.

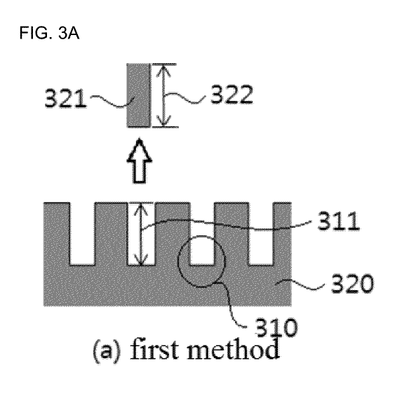

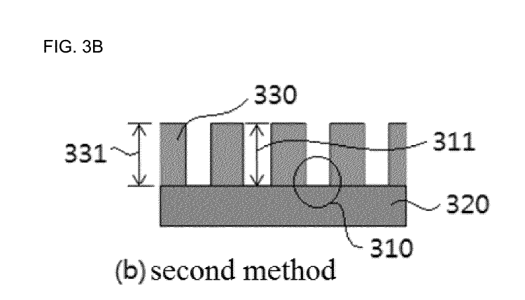

FIGS. 3A and 3B are drawings illustrating a first method and a second method of forming gratings on an optical grating coupler according to an exemplary embodiment of the inventive concept.

Referring to FIGS. 3A and 3B, gratings included in an optical grating coupler according to an exemplary embodiment of the inventive concept may be formed by a variety of methods.

For example, referring to FIG. 3A, a grating 310 may be formed by removing a part 321 of a core layer 320 in which the optical grating coupler is disposed. A depth 311 of the grating 310 may be set based on a height 322 of the removed part 321 of the core layer 320.

Also, referring to FIG. 3B, as one of material which is different from that of the core layer 320 and the same material as that of the core layer 320 is laminated on the core layer 320 where the optical grating coupler is disposed, the grating 310 may be formed. The depth 311 of the grating 310 may be set based on a height 331 of the laminated one of the material which is different from that of the core layer 320 and the same material as that of the core layer 320.

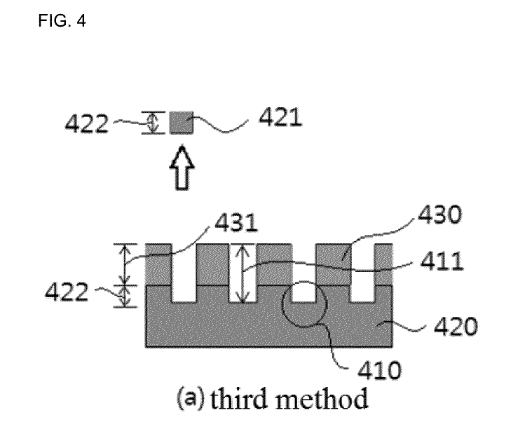

Also, the grating 310 may be formed by all of the first and second methods. A description will be given in detail for this with reference to FIG. 4.

FIG. 4 is a drawing illustrating a third method of forming gratings on an optical grating coupler according to an exemplary embodiment of the inventive concept.

Referring to FIG. 4, a grating included in an optical grating coupler according to an exemplary embodiment of the inventive concept may be formed by a third method to which the above-described first and second methods are applied.

For example, according to the third method, after a part 421 of a core layer 420 in which the optical grating coupler is disposed is removed, as one 430 of material which is different from that of the core layer 420 and the same material as that of the core layer 420 is laminated on the core layer 420, a grating 410 may be formed. Herein, a depth 411 of the grating 410 may be set based on a height 422 of the removed part 421 of the core layer 420 and a height 431 of one of the laminated one of the material which is different from that of the core layer 420 and the same material as that of the core layer 420.

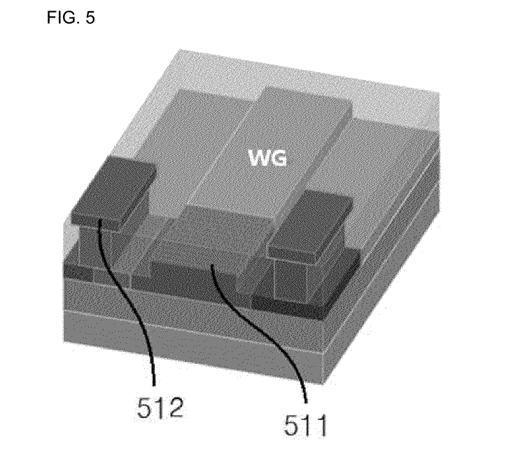

FIG. 5 is a pictorial drawing illustrating an optical grating coupler according to an exemplary embodiment of the inventive concept.

Referring to FIG. 5, the optical grating coupler according to an exemplary embodiment of the inventive concept may tune the center wavelength having maximum efficiency in an active manner by changing the effective refractive index of a grating 511 through electric control. Herein, the effective refractive index of the grating 511 may be changed in response to a signal provided through a pad 512.

The optical grating coupler according to embodiments of the inventive concept may tune the center wavelength in the active manner by changing the effective refractive index through electric control.

The optical grating coupler according to embodiments of the inventive concept may use the thermo-optic effect, the electro-optic effect, and the acousto-optic effect in the process of changing the effective refractive index of the optical grating coupler, which are detailed means of changing the effective refractive index of the optical grating coupler through the electric control.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

What is claimed is:

1. An optical grating coupler including gratings, each of the gratings configured to have a certain period and depth, which is disposed in a waveguide, comprising:
a region for changing the effective refractive index of the optical grating coupler, which is included in the inside or outside of the optical grating coupler,
wherein the region receives a signal for changing the effective refractive index of the optical grating coupler.

2. The optical grating coupler of claim 1, wherein each of the gratings propagates a signal of a center wavelength having a maximum efficiency of the optical grating coupler to the waveguide, and
wherein the center wavelength is tuned in response to a change in the effective refractive index of the optical grating coupler.

3. The optical grating coupler of claim 1, wherein the optical grating coupler is used in an optical switch which selectively tunes a center wavelength having maximum efficiency.

4. The optical grating coupler of claim 1, wherein the optical grating coupler is used in an optical filter which tunes or selects a center wavelength having maximum efficiency.

5. The optical grating coupler of claim 1, wherein the optical grating coupler is used in an optical signal modulator which changes efficiency of coupling about a specific wavelength.

6. The optical grating coupler of claim 1, wherein the effective refractive index of the optical grating coupler is changed by a thermo-optic effect according as a thermal signal is provided to the region for changing the effective refractive index of the optical grating coupler.

7. The optical grating coupler of claim 6, wherein the region for changing the effective refractive index of the optical grating coupler is formed based on at least one of material or semiconductor material having a thermo-optic coefficient of a certain reference value or more to use the thermo-optic effect.

8. The optical grating coupler of claim 6, wherein the region for changing the effective refractive index of the optical grating coupler is formed based on silicon photonics to use the thermo-optic effect, and
wherein the effective refractive index of the optical grating coupler is changed by joule heating according to bias in a PN junction or a P-i-N junction when impurities are doped into the region for changing the effective refractive index of the optical grating coupler.

9. The optical grating coupler of claim 1, wherein the effective refractive index of the optical grating coupler is changed by an electro-optic effect according as an electric signal is supplied to the region for changing the effective refractive index of the optical grating coupler.

10. The optical grating coupler of claim 9, wherein the region for changing the effective refractive index of the optical grating coupler is formed based on at least one of material or semiconductor material having an electro-optic coefficient of a certain reference value or more to use the electro-optic effect.

11. The optical grating coupler of claim 9, wherein the region for changing the effective refractive index of the optical grating coupler is formed based on silicon photonics to use the electro-optic effect, and
wherein the effective refractive index of the optical grating coupler is changed by a carrier plasma dispersion effect in a PN junction or a P-i-N junction when impurities are doped into the region for changing the effective refractive index of the optical grating coupler.

12. The optical grating coupler of claim 1, wherein the effective refractive index of the optical grating coupler is changed by an acousto-optic effect according as an acoustic signal is provided to the region for changing the effective refractive index of the optical grating coupler.
